(19) United States
(12) Patent Application Publication
(10) Pub. No.: US 2020/0362820 A1
(43) Pub. Date: Nov. 19, 2020

(54) COUNTERBALANCED AND COMPENSATED POWER GENERATION SYSTEM

(71) Applicant: HONGFUJIN PRECISION ELECTRONICS (TIANJIN) CO.,LTD., Tianjin (CN)

(72) Inventors: CHAO-KE WEI, New Taipei (TW); CHING-TANG LIU, New Taipei (TW)

(21) Appl. No.: 16/432,172

(22) Filed: Jun. 5, 2019

(30) Foreign Application Priority Data
May 14, 2019 (CN) 201910399593.6

(51) Int. Cl. F03D 9/00; H02K 7/18; F03D 9/25; F03B 13/10; F03B 3/12; F03B 15/00; F03D 7/02

(52) U.S. Cl. CPC F03D 9/008; H02K 7/183; F03D 9/25; F03B 13/10; F05B 2270/321; F03B 15/00; F03D 7/0204; F05B 2270/402; F05B 2210/18; F03B 3/126

(57) ABSTRACT

A power generation system using water power and wind power as two simultaneous energy sources to compensate for and supplement each other includes a power generation unit, a water energy unit, and a wind energy unit. The power generation unit includes a first power generation module and a second power generation module. The first power generation module rotates relative to the second power generation module, cutting a magnetic induction line to generate electrical energy. The water energy unit drives the first power generation module, the wind energy unit drives the second power generation module. The direction of rotation of the water energy unit is opposite to the direction of rotation of the wind energy unit, to rotate the two in opposite directions.

### FIELD

The subject matter herein generally relates to power generation.

### BACKGROUND

Marine energy can be obtained from wind power and wave or ocean power. In the prior art, these two sources are separate, and power generation from the sources can be low due to irregularities of the wind and water movements.

Therefore, there is a room for improvement.

### BRIEF DESCRIPTION OF THE DRAWINGS

Implementations of the present disclosure will now be described, by way of embodiments, with reference to the attached figures.

FIG. 1 is a schematic diagram of an embodiment of a power generation system.

FIG. 2 is a block diagram of an embodiment of the system of FIG. 1.

FIG. 3 is a diagram of another embodiment of the system of FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

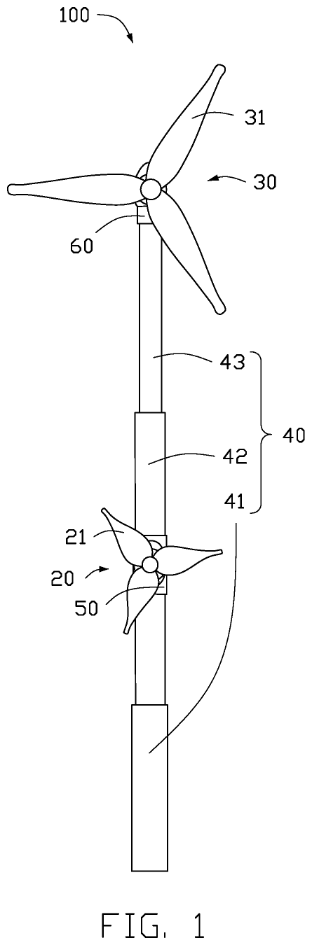

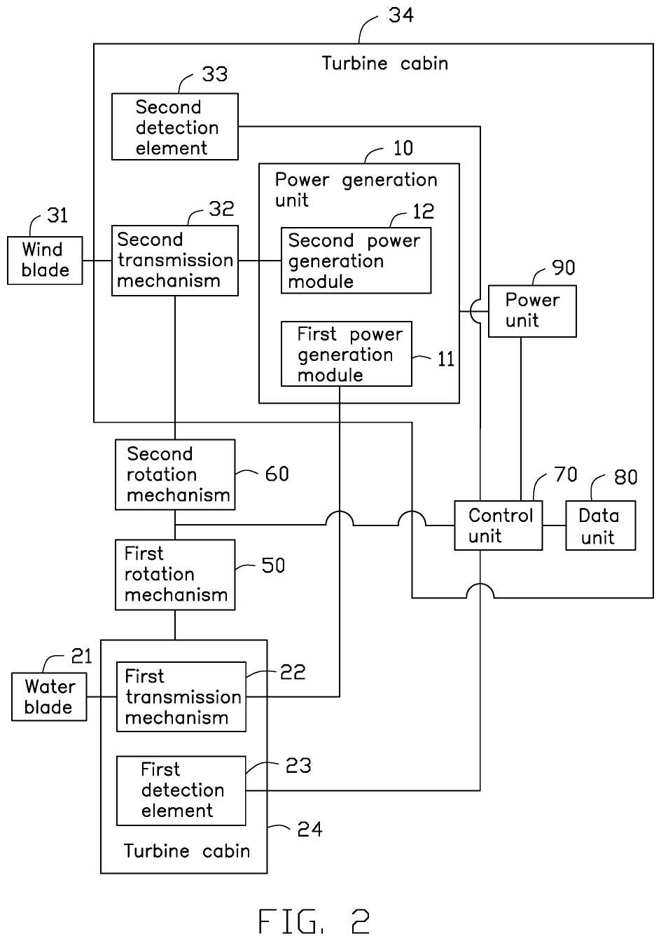

FIGS. 1 and 2 illustrate a power generation system 100 in accordance with an embodiment of the present disclosure. The power generation system 100 is configured to convert wind energy and energy from open-ocean water into electric energy.

In at least one embodiment, the power generation system 100 includes a power generation unit 10, a water energy unit 20, and a wind energy unit 30. The water energy unit 20 includes an output end (not shown), and the wind energy unit 30 includes an output end (not shown).

The power generation unit 10 includes a first power generation module 11 and a second power generation module 12. The first power generation module 11 includes an input end (not shown), and the second power generation module 12 includes an input end (not shown).

The output end of the water energy unit 20 is connected to the input end of the first power generation module 11, to drive the first power generation module 11 to rotate. The output end of the wind energy unit 30 is connected to the input end of the second power generation module 12, to drive the second power generation module 12 to rotate.

When the rotational speed of the first power generation module 11 is faster than the rotational speed of the second power generation module 12, the first power generation module 11 can be regarded as rotor of a generator, and the second power generation module 12 can be regarded as stator of a generator.

When the rotational speed of the first power generation module 11 is slower than the rotational speed of the second power generation module 12, the first power generation module 11 can be regarded as stator of a generator, and the second power generation module 12 can be regarded as rotor of a generator.

In one embodiment, the direction of rotation of the output end of the water energy unit 20 is opposite to the direction of rotation of the output end of the wind energy unit 30. The first power generation module 11 and the second power generation module 12 are thus rotated in opposite directions to cut the magnetic induction line, to generate the desired electricity. Mechanical energy is thus converted into electrical energy.

In at least one embodiment, the power generation system 100 further includes a frame 40. The frame 40 includes a base 41, a first supporting portion 42, and a second supporting portion 43. The first supporting portion 42 is fixed between the base 41 and the second supporting portion 43.

In the embodiment, the base 41 is disposed on sea floor, and the first supporting portion 42 is submerged in sea water. The second supporting portion 43 is extended out over the surface of sea or ocean. In another embodiment, the frame 40 may be installed in another water environment, such as a river.

The wind energy unit 30 and the power generation unit 10 may be disposed at the top of the frame 40. The water energy unit 20 may be disposed on the frame 40, the water energy unit 20 is located below the wind energy unit 30 and the power generation unit 10.

In the embodiment, the water energy unit 20 includes a water blade 21 and a turbine housing or container (turbine cabin 24), and the wind energy unit 30 includes a wind blade 31 and a turbine housing or container (turbine cabin 34). The power generation unit 10 is installed in the turbine cabin 34.

A first transmission mechanism 22 is installed in the turbine cabin 24, and a second transmission mechanism 32 is installed in the turbine cabin 34. The first transmission mechanism 22 includes an input end (not shown) and an output end (not shown). The second transmission mechanism 32 includes an input end (not shown) and an output end (not shown).

The water blade 21 is disposed in front of the turbine cabin 24, and the turbine cabin 24 is rotatably coupled to the first supporting portion 42. The wind blade 31 is disposed in front of the turbine cabin 34, and the turbine cabin 34 is rotatably coupled to the second supporting portion 43.

The water blade 21 is submerged below the surface of the water, and the wind energy unit 30 protrudes above the surface of the water.

In the embodiment, the frame 40 is further provided with a through hole (not shown) which penetrates the first supporting portion 42 and the second supporting portion 43. The water blade 21 is connected to the input end of the first transmission mechanism 22 through an axle (not shown). The output end of the first transmission mechanism 22 passes through the through hole and is connected to the input end of the first power generation module 11.

The wind blade 31 is connected to the input end of the second transmission mechanism 32 through an axle (not shown). The output end of the second transmission mechanism 32 is connected to the input end of the second power generation module 12. In the embodiment, the first transmission mechanism 22 and the second transmission mechanism 32 may include gears.

The water energy unit 20 further includes a first detection element 23, and the wind energy unit 30 further includes a second detection element 33.

The first detection element 23 is installed on the turbine cabin 24, and the second detection element 33 is installed on the turbine cabin 34.

The first detection element 23 detects the direction of water flow, flow rate, and other conditions relating to the water blade 21 in real time.

The second detection element 33 detects the wind flow direction, wind speed, and other related conditions relating to the wind blade 31 in real time.

In at least one embodiment, the power generation system 100 further includes a first rotation mechanism 50 and a second rotation mechanism 60.

The first rotation mechanism 50 is fixed to the turbine cabin 24, and the first supporting portion 42 is rotatably coupled to the first rotation mechanism 50. The second rotation mechanism 60 is fixed to the turbine cabin 34, and the second supporting portion 43 is rotatably coupled to the second rotation mechanism 60. Therefore, the first rotation mechanism 50 and the second rotation mechanism 60 can be rotated by the frame 40 on a central axis.

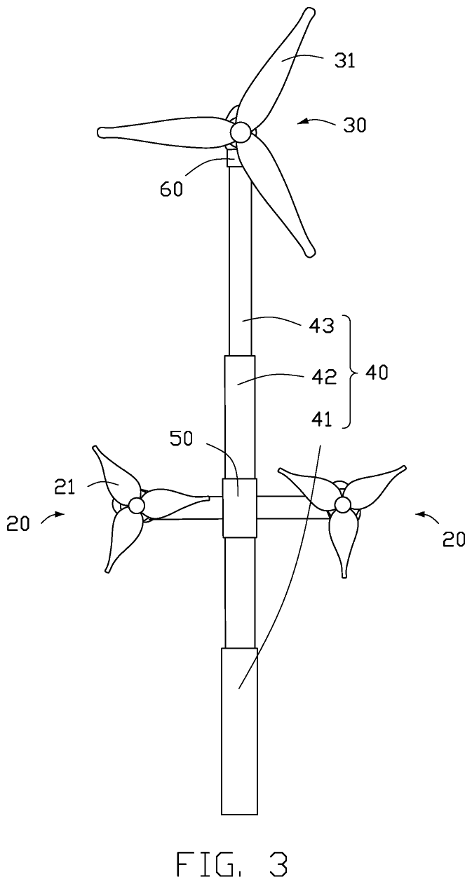

FIG. 3 illustrates two water energy units 20 in the system 100. Two water energy units 20 are symmetrically mounted on both sides of the first supporting portion 42 by the first rotation mechanism 50. In other embodiments, the number of the water energy units 20 may be greater than two.

The power generation system 100 further includes a control unit 70. The control unit 70 is installed in the turbine cabin 34.

The control unit 70 communicates with the first detection element 23 and the first rotation mechanism 50. The control unit 70 obtains the water flow direction from the first detection element 23, and controls rotation of the first rotation mechanism 50 according to the water flow direction, so that the water blade 21 can efficiently face the water.

The control unit 70 outputs a first control signal according to the water flow direction, to establish a transmission connection between the first rotation mechanism 50 and the first transmission mechanism 22. Therefore, the first rotation mechanism 50 can rotate under the transmission of the first transmission mechanism 22, thereby driving the turbine cabin 24 and the water blade 21 to rotate with the frame 40 on a central axis.

The control unit 70 can communicate with the second detection element 33 and the second rotation mechanism 60. The control unit 70 obtains the wind flow direction from the second detection element 33, and controls the rotation of the second rotation mechanism 60 according to the wind flow direction, so that the wind blade 31 can face the wind in an efficient way.

The control unit 70 outputs a second control signal according to the wind flow direction, to establish a transmission connection between the second rotation mechanism 60 and the second transmission mechanism 32. Therefore, the second rotation mechanism 60 can rotate under the transmission of the second transmission mechanism 32, thereby driving the turbine cabin 34 and the wind blade 31 to rotate with the frame 40 on a central axis.

The control unit 70 controls the rotation of the first rotation mechanism 50 and the second rotation mechanism 60 to adjust the respective orientations of the turbine cabin 24 and the turbine cabin 34, such that the water blade 21 and the wind blade 31 face the water and the wind respectively in the most efficient manner possible.

In at least one embodiment, the power generation system 100 further includes a data unit 80 and a power unit 90. The data unit 80 and the power unit 90 are installed in the turbine cabin 34.

The data unit 80 can communicate with the control unit 70. The data unit 80 provides weather data for the control unit 70, the weather data may be temperature, air pressure, wind speed, and flow rate. The control unit 70 can adjust the orientations of the water blade 21 and the wind blade 31 according to the weather data.

The power unit 90 is electrically coupled between the power generation unit 10 and the control unit 70. The power unit 90 is also electrically coupled to an external power system (not shown). The power unit 90 passes on the electrical power generated by the power generation unit 10 to the control unit 70 and the external power system.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. A power generation system comprising:
a power generation unit comprising a first power generation module and a second power generation module; wherein the first power generation module and the second power generation module rotate in opposite directions to cut magnetic induction line to generate electricity;
a water energy unit coupling to the first power generation module, and driving the first power generation module to rotate; and
a wind energy unit coupling to the second power generation module, and driving the second power generation module to rotate;
wherein the direction of rotation of the water energy unit is opposite to the direction of rotation of the wind energy unit, thereby driving the first power generation module and the second power generation module to rotate in opposite directions; and
wherein the water energy unit comprises a water blade and a first turbine cabin, a first transmission mechanism is installed in the first turbine cabin, the first transmission mechanism is coupled between the first power generation module and the water blade; wherein the wind energy unit comprises a wind blade and a second turbine cabin, a second transmission mechanism is installed in the second turbine cabin, the second transmission mechanism is coupled between the second power generation module and the wind blade;
wherein the power generation system further comprises a control unit, the water energy unit further comprises a first detection element, the wind energy unit further comprises a second detection element, the first detection element is installed on the first turbine cabin, and the first detection element detects a direction of water flow through the water blade, the second detection element is installed on the second turbine cabin, and the second detection element detects a direction of wind flow through the wind blade; the control unit communicates with the first detection element and the second detection element, controls the water blade to face the direction of water flow, and controls the wind blade to face the direction of wind flow.

2-7. (canceled)

8. The power generation system of claim 1, wherein the power generation system further comprises a frame and a first rotation mechanism, the first rotation mechanism is fixedly coupled to the first turbine cabin, and the first rotation mechanism is rotatably coupled to the frame.

9. The power generation system of claim 8, wherein the power generation system further comprises a frame and a second rotation mechanism, the second rotation mechanism is fixedly coupled to the second turbine cabin, and the second rotation mechanism is rotatably coupled to the frame.

10-12. (canceled)

13. A power generation system comprising:
a power generation unit comprising a first power generation module and a second power generation module; wherein the first power generation module and the second power generation module rotate in opposite directions to cut magnetic induction line to generate electricity;
a water energy unit coupling to the first power generation module, and driving the first power generation module to rotate; and
a wind energy unit coupling to the second power generation module, and driving the second power generation module to rotate;
wherein the direction of rotation of the water energy unit is opposite to the direction of rotation of the wind energy unit thereby driving the first power generation module and the second power generation module to rotate in opposite directions;
wherein the water energy unit comprises a water blade and a first turbine cabin, a first transmission mechanism is installed in the first turbine cabin, the first transmission mechanism is coupled between the first power generation module and the water blade; and
wherein the wind energy unit comprises a wind blade and a second turbine cabin, a second transmission mechanism is installed in the second turbine cabin, the second transmission mechanism is coupled between the second power generation module and the wind blade;
wherein the power generation system further comprises a control unit, the water energy unit further comprises a first detection element, the wind energy unit further comprises a second detection element, the first detection element is installed on the first turbine cabin, and the first detection element detects a direction of water flow through the water blade, the second detection element is installed on the second turbine cabin, and the second detection element detects a direction of wind flow through the wind blade; the control unit communicates with the first detection element and the second detection element, controls the water blade to face the direction of water flow, and controls the wind blade to face the direction of wind flow.

14-17. (canceled)

18. The power generation system of claim 13, wherein the power generation system further comprises a frame and a first rotation mechanism, the first rotation mechanism is fixedly coupled to the first turbine cabin, and the first rotation mechanism is rotatably coupled to the frame.

19. The power generation system of claim 18, wherein the power generation system further comprises a frame and a second rotation mechanism, the second rotation mechanism is fixedly coupled to the second turbine cabin, and the second rotation mechanism is rotatably coupled to the frame.

20. The power generation system of claim 19, wherein the power generation system further comprises a data unit and a power unit, the data unit communicates with the control unit, and provides weather data for the control unit; wherein the weather data comprises climate temperature, climate air pressure, wind speed, and wind flow rate; wherein the power unit is electrically coupled between the power generation unit and the control unit.
